(19) United States
(12) Patent Application Publication
(10) Pub. No.: US 2004/0168901 A1
(43) Pub. Date: Sep. 2, 2004

(54) Distillation apparatus

(76) Inventor: Lester Payne, Southport, Queensland (AU)

Correspondence Address: HOFFMAN WASSON & GITLER, P.C, CRYSTAL CENTER 2, SUITE 522, 2461 SOUTH CLARK STREET, ARLINGTON, VA, 22202-3843, US

(21) Appl. No.: 10/478,292

(22) PCT Filed: May 29, 2002
(86) PCT No.: PCT/AU02/00683

(30) Foreign Application Priority Data
May 29, 2001 (AU) PR 5335

(51) Int. Cl. B01D 3/00; B01D 3/10

(52) U.S. Cl. 202/186; 202/200; 202/205; 203/87

(57) ABSTRACT

A distillation apparatus for distilling a fluid comprising a boiling chamber for creating at least some vapour from the fluid, having at least one outlet (3, 3a) and a heat adding means (14), at least one condensing chamber (2) associated with the boiling chamber, the at least one condensing chamber (2) having at least one heat removal means (9, 9a, 18, 19, CL) wherein the at least one heat removal means (9, 9a, 18, 19, CL) in the at least one condensing chamber (2) is operable in two conditions, a first condition in which the at least one heat removal means (9, 9a, 18, 19, CL) is removing heat from the system and a second condition in which the at least one heat removal means (9, 9a, 18, 19, CL) is not removing heat from the system, at least one inlet (12) and at least one outlet (3, 3a) associated with the at least one condensing chamber, (2) and at least one pump means (FW, RW) for lowering the pressure to create a low-pressure or partial vacuum environment in the system and also to move the fluid around the system wherein changes in the operable condition of the at least one heat removal means (9, 9a, 18, 19, CL) in the at least one condensing chamber is actuated according to the pressure in the system.

### TECHNICAL FIELD

This invention relates to distillation apparatus for purifying liquids.

### BACKGROUND ART

Distillation involves a process of evaporation and re-condensation for the purpose of separating liquids into various fractions according to their boiling points or boiling ranges.

A basic form of distillation apparatus is a distillation flask.

A distillation flask is a laboratory apparatus usually made of glass. It consists of a bulb with a neck for the insertion of a thermometer and a side tube bypass attached to the neck through which vapours pass and are fed onto a condenser.

It is known that the quality of water can be greatly improved by the distillation process, however a basic form of apparatus mentioned previously will not lend itself to commercially viable processing of water.

To achieve an affective commercial product automation and high volumes are required.

Australian Patent No.660842 (Tajer-Ardebili) describes a water distillation system. The system described is aimed at providing an on-demand water dispenser and can only provide limited quantities of distilled water due to the limitations of heat input and the inability of the vacuum system to handle high inputs.

It is an object of the present invention to provide a distillation process and apparatus which will provide for the efficient high volume production of distilled liquids.

It is also known that the distillation processing involves the heating of a body of liquid carried out in a partial pressure environment.

It is a further object of the present invention to provide a distillation process and apparatus which will provide for efficient high volume and continuous production of distilled liquids under a partial pressure environment.

Further objects and advantages of the present invention will become apparent from the ensuing description which is given by way of example only.

### DISCLOSURE OF INVENTION

According to the present invention there is provided a distillation apparatus comprising:

a boiling chamber having at least one outlet and a heat adding means;

at least one condensing chamber associated with the boiling chamber, the at least one condensing chamber having at least one heat removal means wherein the at least one heat removal means in the at least one condensing chamber is operable in two conditions, a first condition in which the at least one heat removal means is removing heat from the system and a second condition in which the at least one heat removal means is not removing heat from the system;

at least one inlet and at least one outlet associated with the at least one condensing chamber; and

at least one pump means for lowering the pressure to create a low-pressure or partial vacuum environment in the system and also to move the fluid around the system

wherein changes in the operable condition of the at least one heat removal means in the at least one condensing chamber is actuated according to the pressure in the system.

The boiling chamber may preferably be formed with a converging upper surface.

The at least one outlet of the boiling chamber may suitably be equipped with a filter means to filter and remove impurities from the vapour as it leaves the boiling chamber.

The boiling chamber may preferably further comprise a level sensor or switch to control the quantity of fluid entering the boiling chamber for treatment. The amount of fluid in the system is an important operational parameter, as it will directly impact on the amount of heat energy that must be added to the system in order to boil the liquid and, form vapour. A large amount of liquid entering at ambient temperature can slow the system by requiring large amounts of heat to boil the liquid.

There may preferably also be one or more sensors for monitoring the conditions within the boiling chamber. Examples of the parameters that may preferably be measured to increase the degree of control over the process are pressure, temperature, water quantity, vacuum status, amount of vapour and the presence of any faults or problems in the boiling chamber.

The boiling chamber may preferably further comprise a valve for altering the flow from the boiling chamber. This valve may allow the emptying of particularly contaminated water from the boiling chamber without treating it or in combination with other valves, allow isolation of the boiling chamber.

The boiling chamber has heat adding means. The heat adding means may preferably take the form of at least one heat exchange surface having the ability to transfer heat to the fluid in the boiling chamber or to the boiling chamber itself.

The heat adding means may more preferably be a coil through which a heated fluid flows. The coil may preferably be manufactured from metal to facilitate heat transfer. The coil may be of any size suitable for use in a boiling chamber of a particular size. The dimensions of the coil may generally be calculated using thermodynamic or heat transfer principles.

The invention comprises at least one condensing chamber. There may preferably be more than one condensing chamber. Most preferably the invention may comprise three condensing chambers, a first condensing chamber, a second condensing chamber and a third condensing chamber all of which are associated with the boiling chamber.

The first condensing chamber may preferably be positioned above the boiling chamber. The boiling chamber and the first condensing chamber may suitably be separated by the converging upper surface and filter associated with the boiling chamber. As the vaporised fluid leaves the boiling chamber, it may suitably be filtered and then directly enter the first condensing chamber. As such the first condensing chamber may suitably possess only one inlet. The first condensing chamber may however preferably possess at least one outlet and more preferably at may have two outlets.

The vapour converges as it rises and then expands as it passes through the outlet. The gas may then begin to condense and therefore it accumulates above the converging upper surface of the boiling chamber. As the condensate accumulates, it will accumulate at the outer edge of the upper surface first.

The distillation flask comprising the boiling chamber and the first condensation chamber may preferably be designed to possess a particular ration between the boiling surface area and the first condensation surface area. The boiling surface area in this case may preferably include the area of any boiling chamber outlet. In a more preferred form of the present invention, the ratio of boiling, surface area to condensation surface area may be approximately 2:1.

Each outlet may be suitably be positioned in a lower part of the first boiling chamber so that condensing fluid may be properly removed. Each outlet may also preferably be associated with at least one valve. The valve may be a non-return valve to avoid back flushing of the chamber.

There may suitably be one or more sensors associated with the first condensing chamber so that conditions therein may be monitored. The sensors may preferably be linked either directly or indirectly toy valves; or other means for altering one or more of the parameters controlling the conditions in the first condensing chamber.

The at least one heat removal means will preferably have more than one setting for removing heat from the first condensing chamber. The heat removal means may preferably be variable so as to remove heat more quickly or less quickly from the first condensing chamber.

There may suitably be more than one heat removal means associated with each condensing chamber.

Each of the at least one outlet from the first condensing chamber may suitably serve a de-aeration device in a circuit with a vacuum pump.

Each de-aeration device may preferably be associated with the second and third condensing chamber respectively. Each group of aeration device and condensing chamber may also preferably be a single unit.

According to a second broad aspect of the invention, there is provided a tank for incorporation into a distillation apparatus comprising two opposed side walls, two opposed endwalls, a top wall and a bottom wall, at least one inlet and at least one outlet, at least one internal partitioning member having a top lip and a base to divide the interior of the tank into at least two areas, the at least one internal partitioning member having a plurality of apertures at the base thereof to allow fluid to pass under the partition and the top lip of the partition being spaced from the top wall to enable fluid to flow over the partition.

Each tank of this nature may preferably be used as a de-aeration device.

Each de-aeration device may preferably include a means for creating a disturbed water flow for the purposes of aerating water. This means for creating a disturbed water flow may preferably take the form of one or more baffles within the tank. The baffles may suitably have openings disposed through the baffle to facilitate the flow of fluid.

As can be appreciated, the de-aeration tanks may suitably be adapted to aerate or to de-aerate the flow of fluid as required. A rapid turbulent flow may be used to provide aeration to the fluid in the tanks, or a more sedate or laminar flow may de-aerate the fluid by allowing the formation of bubbles of gas, which can then leave the fluid.

Each de-aeration device may suitably be provided with two baffles providing three specific areas a first area, a second area and a third area, within the tank. The first baffle may suitably extend higher than the second baffle each having a folded flange at the top edges thereof and both having a series of apertures therein near the base of the baffle. Water may then be fed under and over the first baffle forcing the air into the headspace of the tank and a similar event occurs as the water passes the second partition. Excess air may then be vented from the tanks.

The first area will preferably be located between the tank end and the second lower baffle. The second area will preferably be between the two baffles and the third are a will preferably be between the first baffle and the end wall of the tank.

The flow pattern in the de-aeration tanks is of particular importance in order to separate oxygen from the water. Each de-aeration tank preferably has two outlets and one inlet. One outlet may preferably be positioned in the first area of the tank. This outlet may preferably be positioned substantially towards the lower part of the tank wall. This outlet will preferably be associated with an abductor and then to a pump before returning to the inlet to the tank.

The inlet to the tank may suitably be located in the tank roof above the third area of the tank. The fluid may then flo through the tank in the manner described above.

There will preferably be a second outlet in the tank roof above the first area of the tank. Fluid leaving the tank through this outlet may preferably proceed to a storage tank.

The first of the outlets may be connected with a de-aeration device and a waste water outlet.

The second of the outlets may be connected with a de-aeration device and a water storage facility.

Each of the de-aeration devices may include means for creating a disturbed water flow for the purpose of aerating water.

Each circuit may also preferably include a condensing chamber.

The first of the outlets may be associated with the second condensing chamber for further condensation or cooling. The second of the outlets may be associated with the third condensing chamber for further condensation or cooling. The second and third condensing chambers may preferably possess any combination of the preferred features of the first condensing chamber.

Each vacuum pump preferably creates a lower pressure environment in the system. A complete vacuum may be practically impossible, but each vacuum pump may assist in the creation and maintenance of a lower pressure environment.

Each vacuum pump may also preferably operate to move the operating fluid of the system (usually water) as a liquid or a vapour or a mixture of these phases. Each pump may also beta variable speed pump in order to suit various production capacities.

Each heat adding means and each heat removing means may preferably be part of or be a complete thermodynamic cycle. An example of such a cycle is one which includes at least one compressor, at least one condenser, at least one expansion device, at least one pump, at least one valve and at least one heat exchange device to transfer heat to or from the working fluid of the cycle. There may be both heaters and coolers in the cycle.

Each heat adding means and each heat removing means may suitably be associated with at least one non-return valve and also at least one pressure regulator to reduce the chance of an unsatisfactory situation arising.

There may preferably be at least one expansion device associated with each heat removal means in the cycle. This means that there will usually be more than one expansion device in the cycle. These expansion devices may preferably be communicable to ensure that a predetermined compression ratio is maintained.

Each heater may preferably comprise primary heat and secondary heat exchange so that heat exchange takes place to vapour returning to the compressor to provide additional heat energy to the vapour and assists to negate steam locking in an associated condensing chamber during the initial start-up period.

There may preferably be one or more storage tanks associated with the system. A storage tank may store the distilled or treated water and another may store water to be treated. A storage tank may be open or closed and may be associated with any attendant means required to move the fluid disposed therein either into or out of the tank. It may also include means for stirring the fluid disposed within.

There may preferably be at least one means associated with the distillation apparatus for testing the quality of the fluid before, during and after treatment. There may also be means to divert contaminated water; away from the treated water tank so as not to lower the quality of water contained therein.

There will suitably be a control system for controlling the process associated with the process. This control system may be automated or manual or contain elements which are both.

According to a third broad aspect of the invention, there is provided an abductor valve for incorporation into a distillation apparatus comprising a substantially solid body portion, the body portion having at least one pair of coaxial openings disposed through the body portion, each pair of openings comprise an inlet opening and an exit opening disposed so that fluid may flow through the body portion from the inlet opening to the outlet opening and a metering portion movable within the at least one opening of the pair of openings to provide an obstruction to the flow of fluid, And thereby alter the flow rate of the fluid through the body portion.

The abductors in the system may preferably be one of three types.

The first type of abductor may preferably comprise a substantially solid body portion. The body portion may suitably have at least one pair of openings disposed through the body portion. There may suitably be more than one pair of openings. A first pair of openings may preferably intersect one or more second pairs of openings. The angle of intersection may suitably be approximately 90 degrees.

Each pair of openings may preferably comprise an inlet opening and an exit opening disposed so that fluid may flow through the body portion from the inlet opening to the outlet opening. Each pair of openings may suitably be coaxial. Associated with at least one of the pairs of openings may preferably be a frustoconical metering portion. The metering portion may preferably be movable within the at least one opening of the pair of openings to provide an obstruction to the flow of fluid, and thereby alter the flow rate of the fluid through the body portion.

A second type of abductor further comprises a means for moving the metering portion. The means for moving the metering portion may preferably be a hollow member having an externally threaded portion for engaging with an internally threaded portion disposed in an inlet opening of a pair of openings. The inlet opening is then preferably through the hollow member. There may preferably be an opening in the metering portion in fluid connection with inlet opening through the hollow member. The hollow member may preferably be associated with a grip enhancing means in the form of a hand-wheel. By turning the hand-wheel, the metering portion may be moved to obstruct a second pair of openings and therefore alter the flow rate through the body portion.

In a third type of abductor the means for moving the metering portion may preferably be mechanical. The means may comprise a housing and an arm member having a cog located at one end. The cog engages with a hollow member having an externally notched portion for engaging with the cog. The inlet opening is then preferably through the hollow member. There may preferably be an opening in the metering portion in fluid connection with inlet opening through the hollow member. The arm member may preferably be associated with a motor for rotating the arm member and thereby the metering portion may be moved to obstruct a second pair of openings and therefore alter the flow rate through the body portion. An electrical device e.g. a solenoid may preferably control the motor and actuate the movement.

### BRIEF DESCRIPTION OF THE DRAWINGS

Aspects of the present invention will now be described with reference to the accompanying drawings in which;

FIG. 1 is a schematic diagram of a water distillation system according to one possible aspect of the present invention.

FIG. 2 is a perspective view of a flask and condensing chamber (with condensing coils removed) according to one aspect of the present invention.

FIGS. 3, 3a and 3b are plan, end and cross-sectional views respectively of a de-aeration tank according to a further aspect of the present invention.

FIGS. 4, 5, 6, 7 and 8 are perspective, plan, end, side and cross-sectional views of one form of an abductor according to the present invention.

FIGS. 9, 10, 11, and 12 are perspective, plan, side and end views of a second form of abductor according to the present invention.

FIGS. 13, 14, 15 and 16 are perspective, plan, side and end views of a third form of abductor according to the present invention.

### BEST MODE

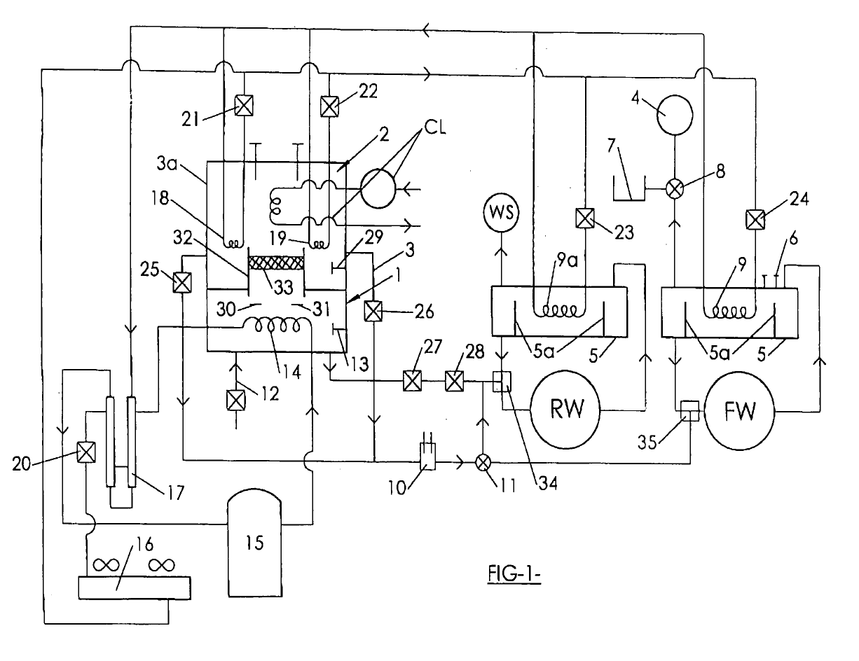

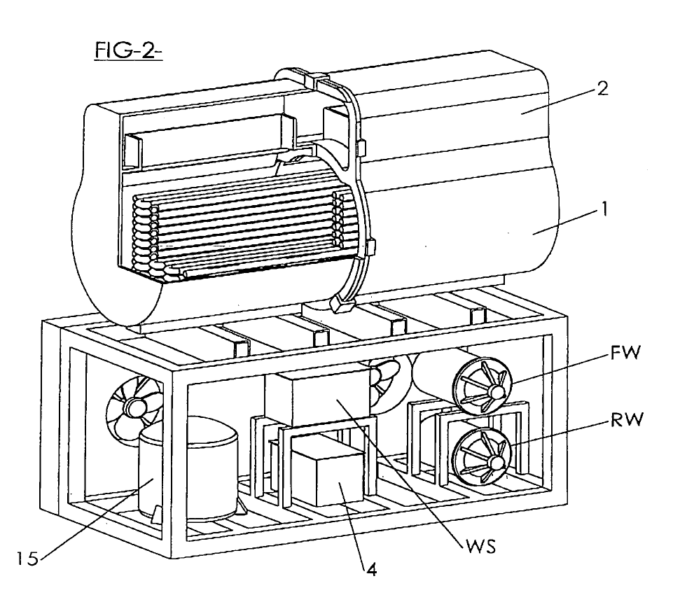

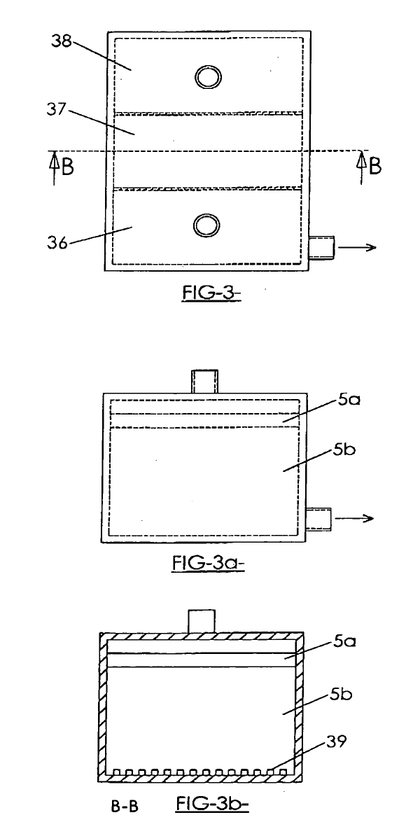

Aspects of the distillation apparatus according to an aspect of the present invention is shown in FIGS. 1-16. The apparatus comprises a boiling chamber 1 generally indicated by arrow, a condensation chamber 2 generally indicated by arrow associated with the boiling chamber 1, and outlets 3 and 3a from the condensation chamber 2. The integrally formed boiling chamber and condensing chamber 2 are called a flask.

Outlet 3a feeds condensation to a storage facility 4 via a pump FW and a tank 5.

The pump FW draws water from condensing chamber 2 to the tank which has a de-aeration function.

Water is dispersed from the tank 5 to the storage facility 4 under pressure.

Water quality sensors 6, will operate to divert contaminated water from the tank 5 to a waste 7 via valve 8 within the tank 5 A cooling coil 9 cools the water to a temperature below approximately 40 degrees Celsius.

The water from outlet 3a is checked by a sensor 10 which is adapted to operate valve 11 to divert contaminated water to a second tank 5 associated with pump RW.

The quantity of water for treatment entering the boiling chamber 1 via entry 12 is controlled by a float (level switch) 13.

Water within the boiling chamber 1 is heated by coils 14 which are in a closed circuit which includes compressor 15, air-cooled condenser 16, and a super heater 17.

The compressor 15 compresses vapour and ensures elevated temperatures.

The super heater 17 absorbs the remaining heat from coil 14 which is communicable with returning vapour from coils 18, 19 in the headspace of the condensing chamber 2.

Pressure regulator 20 ensures that fluid can only pass through the regulator at a predetermined pressure.

The heat exchanger 16 acts as a sub-cooler of liquid (at that stage) to feed cooling fluids to coils 9, 9a, 18 and 19 via pressure reducing devices (refrigerant expansion devices) 21, 22, 23, 24.

The devices 21, 22, 23, 24, are communicable to ensure predetermined compression ratios are maintained.

Non-return valves (NRVs) 25, 26, 27 avoid back flushing.

Valve 28 is a cock valve (manual) shut off valve which enables flow to be altered to suit different waters, and a vacuum sensor 29 will shut off the machine if vacuum is lost.

Sensors 30, 31 will shut down valve on the entry 12 in the event of foaming occurring in the flask, and in addition can be electrically connected to pumps RW and FW to control input.

Abductors 34, 35, are orifice type valves, which are operable to provide vacuums to suit various production capacities.

The abductors may comprise a housing and plunger which is controlled by an electrical device e.g. a solenoid. These valves have a fixed or adjustable orifice allowing the pumps RW and FW to adapt to the level of vacuum present in the system. The also allow the system to be adjusted to treat source water with differing levels of contaminants by changing the level of vacuum in the system. A higher pressure will result in less liquid being boiled for the same heat input which means the water will be less treated. This may be the situation where heavily contaminated water is being treated. Thus, water may pass through the system without being treated if it is too contaminated.

The boiling chamber 1 and condensation chamber 2 are divided by a funnel 32 and filter 33.

The tanks 5 each of which have an de-aeration function are provided with internal baffles 5a, 5b which act to aerate water as it flows from a point of entry to a point of exit.

Each tank 5 is provided with two partitions/baffles 5a providing three specific areas a first area 36, a second area 37 and a third area 38, within the tank. One partition/baffle 5a is, higher than the other 5b, each having a folded flange at the top edge thereof and both having a series of apertures 49 therein near the base thereof.

Water is then fed under and over the first baffle 5a forcing the air into the headspace of the tank 5 and a similar event occurs as the water passes the second baffle 5b. Excess air may then be vented from the tanks 5.

The first area 36 is located between the tank end and the second lower baffle 5b. The second area 37 is between the two baffles 5a, 5b and the third area 38 lies between the first baffle 5a and the end wall of the tank 5.

The flow pattern in the de-aeration tanks 5 is of particular importance in order to separate oxygen from the water. Each de-aeration tank 5 has two outlets and one inlet. One outlet is positioned in the first area 36 of the tank 5. This outlet is positioned substantially towards the lower part of the tank wall. This outlet is associated with an abductor 34 and then a pump RW before returning to the inlet to the tank 5.

The inlet to the tank 5 is located in the tank roof above the third area 38 of the tank 5. The fluid then flows through the tank 5 in the manner described above.

There is a second outlet in the tank roof above the first area 36 of the tank. Fluid leaving the tank through this outlet proceeds to a storage tank WS, 7.

The heater 17 comprise primary heat and secondary heat exchange so that heat exchange takes place to vapour returning to the compressor to provide additional heat energy to the vapour and assists to negate steam locking in the condensing chamber 2 during the initial start-up period.

When water is boiled under a high volume the less energy is required. Additional cooling apparatus CL at FIG. 1 can be associated with the condensation chamber 2. The cooling apparatus can be set up to monitor temperatures within the environment and to be activated to reduce pressures when required.

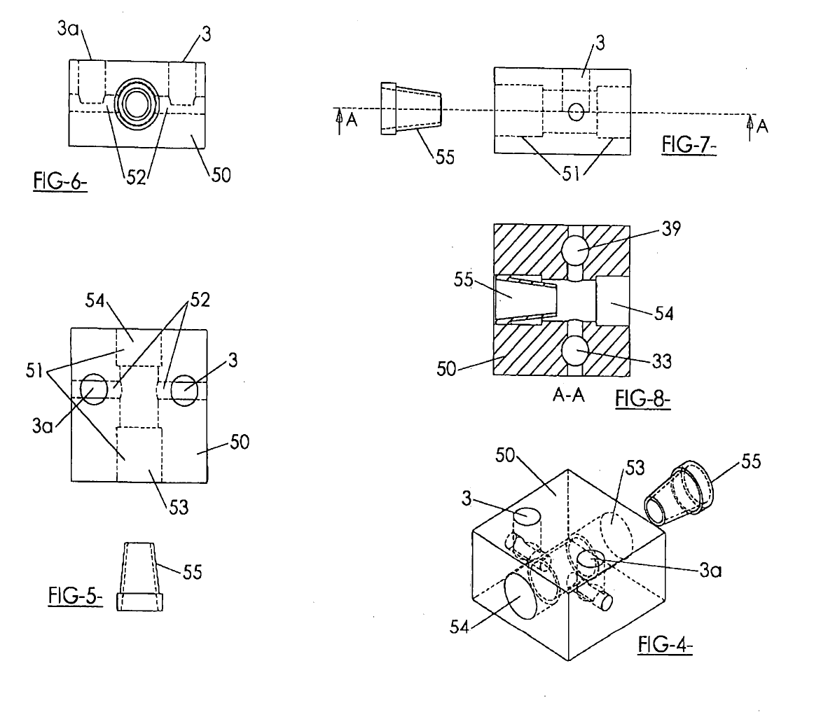

The abductors utilised in the system are one of the three types shown in FIGS. 4-16. The first type of abductor shown in FIGS. 4-8 comprises a substantially solid body portion 50. The body portion 50 has more than one pair of openings disposed through the body portion 50. A first pair of openings 51 intersects two second pairs of openings 52 and the angle of intersection is approximately 90 degrees.

Each pair of openings comprises an inlet opening 53 and an exit opening 54 disposed so that fluid flows through the body portion 50 from the inlet opening 53 to the outlet opening 54. Associated with at least one of the pairs of openings is a frustoconical metering portion 55. The metering portion is movable within the at least one opening of the pair of openings to provide an obstruction to the flow of fluid, and thereby alter thee flow rate of the fluid through the body portion 50.

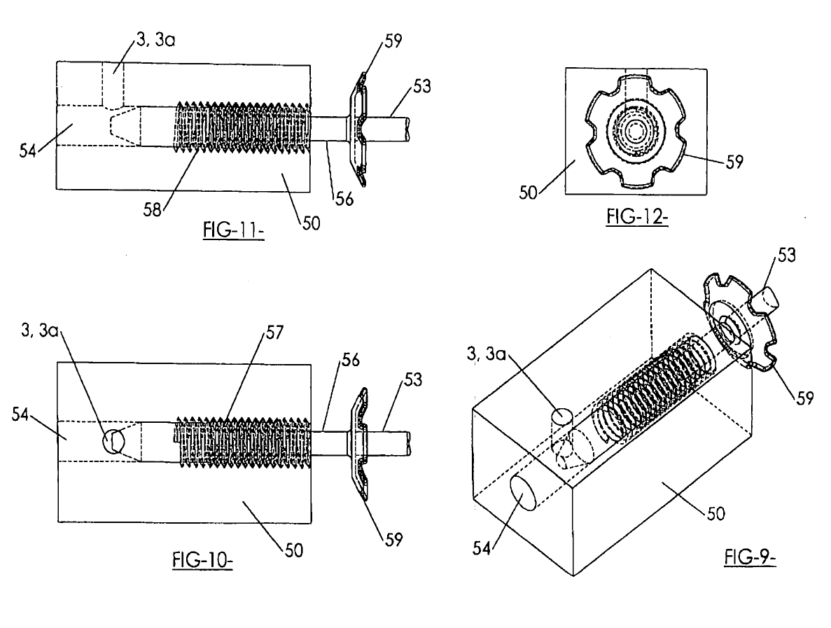

A second type of abductor shown in FIGS. 9-12 further comprises a means for moving the metering portion 56. The means for moving the metering portion is a hollow member having an externally threaded portion 57 for engaging with an internally threaded portion 58 disposed in an inlet opening 53 of a pair of openings. The inlet opening 53 is then disposed through the hollow member. There is an opening in the metering portion 55 in fluid connection with inlet opening 53 through the hollow member. The hollow member is associated with a grip enhancing means in the form of a hand-wheel 59. By turning the hand-wheel 59, the metering portion 55 can be moved to obstruct a second pair of, openings and therefore alter the flow rate through the body portion.

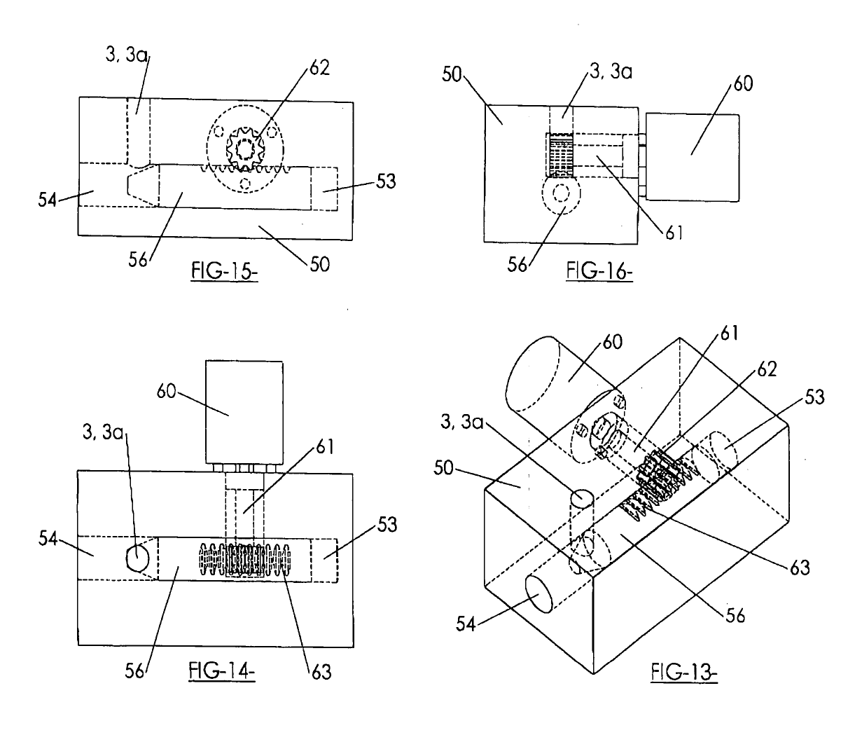

In a third type of abductor shown in FIGS. 13-16 the means for moving the metering portion 56 is mechanical. The means comprises a housing 60 and an arm member 61 having a cog 62 located at one end. The cog 62 engages with a hollow member having an externally notched portion 63 for engaging with the cog 62. The inlet opening 53 is then disposed through the hollow member. There is an opening in the metering portion 55 in fluid connection with inlet opening 53 through the hollow member. The arm member is associated with a motor located in the housing 60 form rotating the arm member 61 and thereby the metering portion 55 can be moved to obstruct a second pair of openings and therefore alter the flow rate through the body portion. An electrical device e.g. a solenoid may preferably control the motor and actuate the movement.

The following block diagram illustrates aspects if the process which can be electrically controlled and coordinated along with manual intervention as necessary.

CONTROLLER

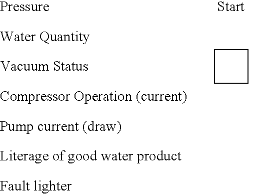

Invention has the following advantages among others.

(a) That is can process seawater, contaminated water, can draw from dirty rivers, ocean, stormwater, mains supply

(b) Water out of system is very acidic can be used for medicinal purposes.

(c) Continuous quantities of distilled waters (useful in remote areas) where have power but very little pure water.

(d) The apparatus can be large/small in terms of size depending on requirements.

(e) Recycle waste waters can be processed for non-drinking use.

Aspects of the present invention have been described by way of example only and it will be appreciated that modifications and additions thereto may be made without departing from the scope thereof, as defined in the appended claims.

The claims defining the invention are as follows:

1. A distillation apparatus for distilling a fluid comprising:
a boiling chamber for creating at least some vapour from the fluid, having at least one outlet and a heat adding means;
at least one condensing chamber associated with the boiling chamber, the at least one condensing chamber having at least one heat removal means wherein the at least one heat removal means in the at least one condensing chamber is operable in two conditions, a first condition in which the at least one heat removal means is removing heat from the system and a second condition in which the at least one heat removal means is not removing heat from the system;
at least one inlet and at least one outlet associated with the at least one condensing chamber; and
at least one pump means for lowering the pressure to create a low-pressure or partial vacuum environment in the system and also to move the fluid around the system
wherein changes in the operable condition of the at least one heat removal means in the at least one condensing chamber is actuated according to the pressure in the system.

2. The distillation apparatus of claim 1 wherein the boiling chamber is formed with a converging upper surface.

3. The distillation apparatus of claim 1 wherein the at least one outlet of the boiling chamber is equipped with a filter means to filter and remove impurities from the vapour as it leaves the boiling chamber.

4. The distillation apparatus of claim 1 wherein the at least one condensing chamber is separated form the boiling chamber by the converging upper surface and filter associated with the boiling chamber

5. The distillation apparatus of claim 1 wherein the at least one heat removal means is variable to remove heat more quickly or less quickly from the at least one condensing chamber.

6. The distillation apparatus of claim 1 wherein the apparatus comprises three condensing chambers, a first condensing chamber, a second condensing chamber and a third condensing chamber, all of which are associated with the boiling chamber.

7. The distillation apparatus of claim 6 wherein each of the at least one outlets from each condensing chamber serve a de-aeration device in a circuit with a vacuum pump.

8. The distillation apparatus of claim 7 wherein each de-aeration device condensing chamber are a single unit.

9. The distillation apparatus of claim 7 wherein each de-aeration device includes a means for creating a disturbed water flow for the purposes of aerating water.

10. The distillation apparatus of claim 1 wherein each heat adding means and each heat removing means are part of or are a complete thermodynamic cycle.
